(19) United States
(12) Patent Application Publication
(10) Pub. No.: US 2013/0016192 A1
(43) Pub. Date: Jan. 17, 2013

(54) IMAGE PROCESSING DEVICE AND IMAGE DISPLAY SYSTEM

(71) Applicant: Motohiro SHIBATA, Tokyo (JP)

(72) Inventor: Motohiro SHIBATA, Tokyo (JP)

(73) Assignee: OLYMPUS CORPORATION, Tokyo (JP)

(21) Appl. No.: 13/539,762

(22) Filed: Jul. 2, 2012

(30) Foreign Application Priority Data
Jul. 12, 2011 (JP) 2011-154090

(51) Int. Cl. H04N 13/04; H04N 7/18

(52) U.S. Cl. 348/51; 348/79; 348/E07.085; 348/E13.026

(57) ABSTRACT

An image processing device forms an omnifocal image and/or a three-dimensional image based on a group of images captured while moving along a fixed axis. The image processing device includes a detecting unit that detects a shift in a plane vertical to the axis of images in the group of the image; a correcting unit that corrects the shift according to a result detected at the detecting unit; and an image forming unit that forms an omnifocal image and/or a three-dimensional image based on the group of the images including images captured while moving along the fixed axis and/or an image corrected at the correcting unit.

### CROSS-REFERENCE TO RELATED APPLICATION

This application is based upon and claims the benefit of priority from Japanese Patent Application No. 2011-154090, filed on Jul. 12, 2011, the entire contents of which are incorporated herein by reference.

### BACKGROUND OF THE INVENTION

1. Field of the Invention

The present invention relates to an image processing device and an image display system that process images captured by a CCD (Charge-Coupled Device) camera, for example.

2. Description of the Related Art

Heretofore, in the fields of medicine, biology, and the like, microscopes are used in which for the observation of cells or the like, a specimen is illuminated and observed. Also in the industrial fields, microscopes are used in various purposes such as the quality management of metal structures and the like, the research and development of new materials, and the inspection of electronic devices and magnetic heads. For the observation of a specimen using a microscope, such a configuration is known in which an imaging device such as a CCD camera is used to capture a specimen image and the specimen image is displayed on a monitor, in addition to a configuration of observation with eyes.

In a device having an optical system with a shallow focal length like a microscope, it was difficult to grasp a specimen entirely in observation. Thus, it is demanded to form, from images captured by a CCD camera or the like, an omnifocal image that is an image in which the entire region of an image achieves focus and a three-dimensional image that is an image to easily grasp irregularities.

To this demand, a method is disclosed in which an omnifocal image and a three-dimensional image are formed based on images captured at predetermined intervals in the height direction of a specimen (for example, see Japanese Laid-open Patent Publication No. 2010-117229). In this method, for example, a derivative of brightness between pixels and neighboring pixels in an image is calculated, this derivative is used as an evaluation value to compare this evaluation value with the evaluation value of different images captured along the same height direction, and an image with the highest evaluation value is considered to have the focal point of the pixel of this image in the height direction for forming an omnifocal image. Since coordinates in the height direction are known in the images, a three-dimensional image can also be formed based on distances calculated from the coordinates.

This method is generally called the Shape From Focus (SFF) method. Furthermore, in addition to the SFF method, there are the Depth From Focus (DFF) method that calculates a distance from an in-focus position in achieving focus, and the Depth From Defocus (DFD) method that analyzes a blur to estimate a focal point. Also in the DFD method, an omnifocal image and a three-dimensional image can be formed.

### SUMMARY OF THE INVENTION

An image processing device according to an aspect of the present invention forms at least one of an omnifocal image and a three-dimensional image based on a group of images captured while moving along a fixed axis, the image processing device including: a detecting unit that detects a shift in a plane vertical to the axis of images in the group of the images; correcting unit that corrects the shift according to a result detected at the detecting unit; and an image forming unit that forms at least one of an omnifocal image and a three-dimensional image based on the group of the images including at least one of images captured while moving along the fixed axis and an image corrected at the correcting unit.

An image display system according to another aspect of the present invention includes the image processing device; and a display unit configured to display at least one of the omnifocal image and the three-dimensional image formed at the image processing device.

The above and other features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of the overall configuration of a microscope system according to an embodiment of the present invention;

FIG. 2 is a flowchart of image processing performed by the microscope system according to an embodiment of the present invention;

FIG. 3 is a flowchart of a first modification of image processing performed by the microscope system according to an embodiment of the present invention;

FIG. 4 is a flowchart of a second modification of image processing performed by the microscope system according to an embodiment of the present invention; and

FIG. 5 is a flowchart of a third modification of image processing performed by the microscope system according to an embodiment of the present invention.

### DETAILED DESCRIPTION OF THE PREFERRED EMBODIMENTS

In the following, a best mode for carrying out the present invention will be described in detail with reference to the drawings. It is noted that the present invention is not limited to an embodiment below. In the following description, shapes, size, and position relationship are merely schematically depicted in the drawings to the extent that the content of the present invention can be understood. Thus, the present invention is not limited only to shapes, size, and position relationship exemplified in the drawings. Furthermore, in the drawings, hatching in cross sections is partially omitted for clarifying configurations. In addition, numeric values exemplified later are merely preferable examples according to the present invention. Therefore, the present invention is not limited to the exemplified numeric values.

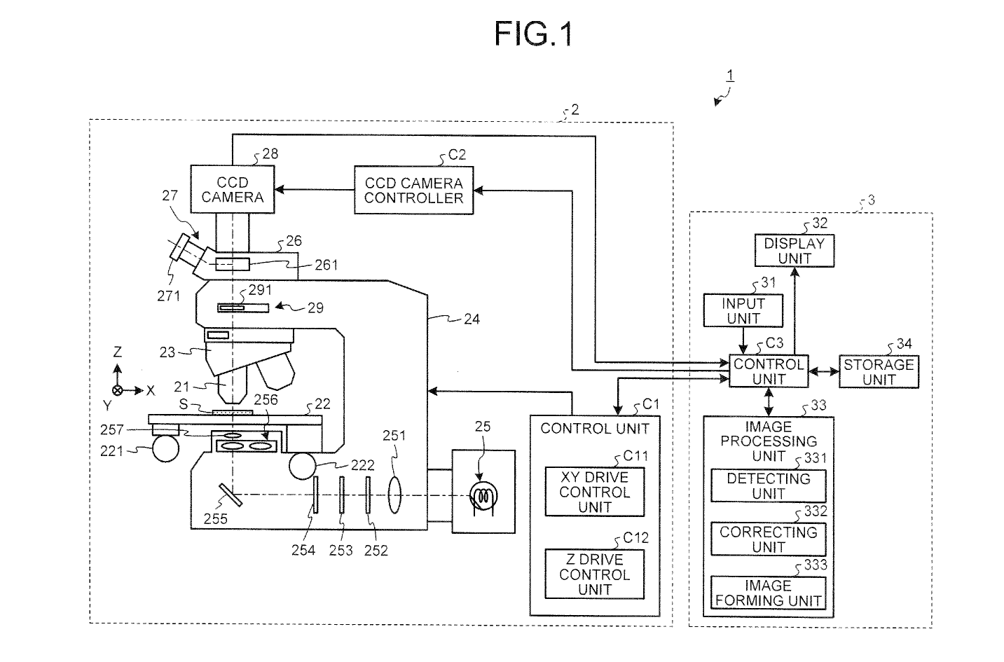

First, the configuration of a microscope system 1 according to an embodiment will be described. FIG. 1 is a schematic diagram of an exemplary overall configuration of the microscope system 1. As depicted in FIG. 1, the microscope system 1 is configured in which a microscope device 2 is connected to a host system 3 to be an image display system as the microscope device 2 and the host system 3 can send and receive information with each other. In the following, the optical axis direction of an objective lens 21 depicted in FIG. 1 is defined as a Z-direction, and a plane vertical to the Z-direction is defined as an XY-plane.

The microscope device 2 includes a motor-operated stage 22 on which a specimen S is placed, a microscope main body 24 in an almost U-shape when seen from the side surface to support the motor-operated stage 22 and hold the objective lens 21 through a revolver 23, a light source 25 disposed on the bottom part on the rear side of the microscope main body 24 (on the right side in FIG. 1), and a lens barrel 26 placed on the upper part of the microscope main body 24. The lens barrel 26 is mounted with a binocular unit 27 that visually observes the specimen image of the specimen S and a CCD camera 28 that captures the specimen image of the specimen S. The microscope device 2 includes a control unit C1 that overall controls the operations of the units forming the microscope device 2.

The motor-operated stage 22 is configured movably (movably in the XYZ-direction in the drawing). More specifically, the motor-operated stage 22 is movable in the XY-plane by a motor 221 that moves the mounting surface of the motor-operated stage 22 for the specimen S on a plane (XY-plane) parallel with the mounting surface and an XY drive control unit C11 that controls the drive of this motor 221. Under the control of the control unit C1, the XY drive control unit C11 detects a predetermined origin point position on the XY-plane of the motor-operated stage 22 using an origin point sensor for XY positions, not shown, and controls the drive value of the motor 221 as this origin point position is a base point for moving an observation location on the specimen S. The XY drive control unit C11 then appropriately outputs the X position and Y position of the motor-operated stage 22 in observation to the control unit C1.

The motor-operated stage 22 is movable in the Z-direction by a motor 222 that moves the mounting surface of the motor-operated stage 22 for the specimen S in the direction (in the Z-direction) vertical to the mounting surface (the XY-plane) and a Z drive control unit C12 that controls the drive of this motor 222. Under the control of the control unit C1, the Z drive control unit C12 detects a predetermined origin point position in the Z-direction of the motor-operated stage 22 using an origin point sensor for Z positions, not shown, and controls the drive value of the motor 222 as this origin point position is a base point for moving the specimen S to a given Z position in a range of a predetermined height for focusing. The Z drive control unit C12 then appropriately outputs the Z position of the motor-operated stage 22 in observation to the control unit C1.

The revolver 23 is rotatably held on the microscope main body 24, and arranges the objective lens 21 above the specimen S. The objective lens 21 is exchangeably mounted on the revolver 23 together with other objective lenses with different magnifications (observation magnifications). The objective lens 21 is inserted on the optical path of observation light according to the rotation of the revolver 23, and the objective lens 21 for use in observing the specimen S is alternatively selected. In the first embodiment, the revolver 23 holds a plurality of objective lenses with different magnifications. Suppose that the revolver 23 holds, for the objective lens 21, at least one objective lens with a relatively low magnification such as 2× and 4× objective lenses (in the following, appropriately referred to “a low magnification objective lens”) and at least one objective lens with a higher magnification such as 10×, 20×, and 40× objective lenses than a low magnification objective lens (in the following, appropriately referred to as “a high magnification objective lens”). However, magnifications such as low magnifications and high magnifications are an example. It is sufficient that the revolver 23 holds an objective lens with a magnification lower than a predetermined magnification and an objective lens with a magnification higher than a predetermined magnification.

The microscope main body 24 includes an illumination optical system on the bottom part therein to provide transmitted-light illumination onto the specimen S. This illumination optical system is configured, for example, in which a collector lens 251 that collects luminous light emitted from the light source 25, a lighting filter unit 252, a field stop 253, an aperture diaphragm 254, a deflection mirror 255 that deflects the optical path of luminous light along the optical axis of the objective lens 21, a capacitor optical element unit 256, a top lens unit 257, and so on are arranged at appropriate locations along the optical path of luminous light. The luminous light emitted from the light source 25 is applied onto the specimen S by the illumination optical system, and enters the objective lens 21 as observation light.

The microscope main body 24 includes a filter unit 29 on the upper part therein. The filter unit 29 rotatably holds a plurality of optical filters 291 that restrict an optical waveband range to a predetermined range to form an image as a specimen image, and appropriately inserts an optical filter 291 for use on the optical path of observation light in the subsequent stage of the objective lens 21. The observation light passed through the objective lens 21 enters the lens barrel 26 through this filter unit 29.

The lens barrel 26 includes a beam splitter 261 therein that switches the optical path of the observation light passed through the filter unit 29 and guides the observation light to the binocular unit 27 or the CCD camera 28. The specimen image of the specimen S is introduced into the binocular unit 27 by this beam splitter 261, and visually observed by an operator through an ocular 271 or captured at the CCD camera 28.

The CCD camera 28 is configured to include an imaging device such as a CCD and a CMOS to form an image of a specimen image (the visual field range of the objective lens 21 in detail). The CCD camera 28 images the specimen image, and outputs the image data of the specimen image to the host system 3. The CCD camera 28 converts incoming observation light into electric signals to acquire the image of the specimen S.

Here, as depicted in FIG. 1, the microscope device 2 includes the control unit C1 and a CCD camera controller C2. Under the control of the host system 3, the control unit C1 overall controls the operations of the units forming the microscope device 2. For example, the control unit C1 adjusts the units of the microscope device 2 in association with the observation of the specimen S such as the process of rotating the revolver 23 to select the objective lens 21 to be arranged on the optical path of the observation light, controlling the intensity of the light source 25 or switching various optical elements according to the magnification or the like of the selected objective lens 21, or instructing the XY drive control unit C11 and the Z drive control unit C12 to move the motor-operated stage 22, and the control unit C1 appropriately notifies the host system 3 of the states of the units. Under the control of the host system 3, the CCD camera controller C2 switches between turning ON and OFF automatic gain control, sets gains, switches between turning ON and OFF automatic exposure control, sets exposure time, or the like to drive the CCD camera 28 for controlling the imaging operation of the CCD camera 28.

The host system 3 includes an input unit 31, a display unit 32, an image processing unit 33, a storage unit 34, and a control unit C3 that instructs the timing to operate the units forming the host system 3, transfers data, and overall controls the operations of the units.

The input unit 31 is implemented using a keyboard, a mouse, a touch panel, and various switches, for example, and outputs manipulation signals corresponding to manipulation inputs to the control unit C3. The display unit 32 is implemented using a display device such as a CRT (Cathode Ray Tube), an LCD (Liquid Crystal Display), and an organic EL (Electroluminescence) display, and displays various screens based on display signals inputted from the control unit C3. In the case where the display unit 32 has a touch panel function, the display unit 32 may also serve as the function of the input unit 31.

The image processing unit 33 functions as an image processing device, in which the specimen image captured at the microscope device 2 is acquired together with observation mode information through the control unit C3 for image-processing the specimen image according to the observation mode when imaged. More specifically, the image processing unit 33 applies necessary image processing to a specimen image acquired in a normal observation mode, and stores the specimen image in the storage unit 34 through the control unit C3, or outputs the specimen image to the display unit 32 for display.

The image processing unit 33 includes a detecting unit 331 that moves in the Z-direction to detect a shift in the XY-plane in pixels forming images captured at a predetermined interval, a correcting unit 332 that corrects a shift in the XY-plane in a subject image according to the result detected at the detecting unit 331, and an image forming unit 333 that forms an omnifocal image or a three-dimensional image based on images captured at the CCD camera 28 including images corrected at the correcting unit 332.

The storage unit 34 is implemented using various IC memories such as an updatable and storageable flash memory including a ROM and a RAM, a built-in hard disk or a hard disk connected to a data communication terminal, a storage medium such as a CD-ROM, and a reader/writer for the storage medium, for example. This storage unit 34 is recorded with programs to operate the host system 3 and implement various functions included in this host system 3, such as an image processing program according to the embodiment and data used in running this program, for example.

It is noted that the host system 3 can be implemented by a publicly known hardware configuration including a CPU, a video board, a main storage device such as a main memory, an external storage device such as a hard disk and various storage media, a communication device, an output device such as a display device and a printing device, an input device, an interface device that connects the units or connects external input, and so on. For example, a multi-purpose computer such as a workstation and a personal computer can be used.

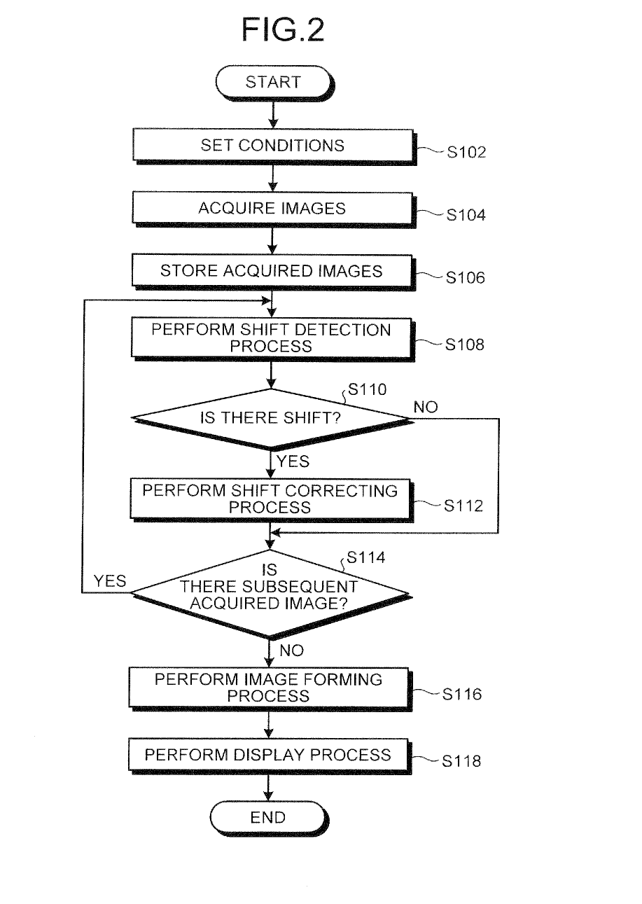

Next, image processing performed by the control unit C3 of the microscope system 1 according to the embodiment will be described with reference to FIG. 2. First, the control unit C3 acquires conditions related to image processing from the input unit 31, and sets the conditions (Step S102). In setting the conditions in Step S102, the range of the specimen S in the Z-direction and a pitch (an imaging interval) are set.

Subsequently, the control unit C3 instructs the Z drive control unit C12 and the CCD camera controller C2 to image a specimen S (Step S104). The control unit C3 acquires images (Z stack images) on the same XY-plane and different in the Z-direction at the pitch set in Step S102 for each of a plurality of XY-planes in the imaging region.

In this acquiring, the Z drive control unit C12 moves the motor-operated stage 22 to a position matched with one end of the specimen S in the Z-direction, and moves the motor-operated stage 22 in the range in the Z-direction set in Step S102. Here, the Z drive control unit C12 may repeatedly move and stop the motor-operated stage 22 at every pitch set in Step S102, or may continuously move the motor-operated stage 22 at a certain speed. Preferably, the range in the Z-direction where the motor-operated stage 22 to be moved is the depth of focus of a scale-up optical system including the objective lens 21 or less. Thus, in the Z stack images in the imaging regions (at the same XY coordinates) of the specimen S, at least one focused image can be acquired.

After acquiring the image, the control unit C3 stores the acquired image in the storage unit 34 (Step S106). The control unit C3 stores the image in association with at least the center coordinates (x, y, z) of the image in the storage unit 34.

After storing the image in the storage unit 34, the control unit C3 instructs the detecting unit 331 to detect whether a shift occurs in the XY-direction in the pixels of the Z stack images (Step S108). Here, the shift detection performed at the detecting unit 331 is performed by template matching or a matching process using feature points in corner detection or the like. In this detection, a template image for shift detection may be the first image of the Z stack images, or may be a Z stack image immediately before (a Z stack image a pitch before) a Z stack image to be a subject for shift detection. The detecting unit 331 acquires a Z stack image to be a subject for shift detection and the first image of the Z stack images or a Z stack image immediately before the Z stack image to be a subject for shift detection from the storage unit 34 to detect the presence or absence of a shift.

When the detecting unit 331 detects a shift between the Z stack images (Step S110: Yes), the control unit C3 instructs the correcting unit 332 to correct the shift between the Z stack images (Step S112). The correcting unit 332 corrects (interpolates) the shift using the nearest neighbor method, the bilinear method, or the bicubic method, for example. The corrected Z stack image is again stored in the storage unit 34. In this storage, the storage unit 34 may replace an image acquired by the CCD camera 28 with the corrected Z stack image, or may store these images separately.

On the other hand, in the case where the detecting unit 331 detects no shift between the Z stack images (Step S110: No), the control unit C3 moves to Step S114, and determines whether there is a subsequent acquired image.

After finishing the shift correcting process, the control unit C3 determines whether there is a subsequent acquired image (a Z stack image) for shift detection. In the case where there is no subsequent acquired image (Step S114: No), the control unit C3 instructs the image forming unit 333 to form an omnifocal image or a three-dimensional image using the Z stack images acquired in Step S104 or the Z stack image corrected in Step S112 (Step S116). In the case where there is a subsequent acquired image for shift detection (Step S114: Yes), the control unit C3 moves to Step S108, and causes the detecting unit 331 to apply the shift detection process to the subsequent acquired image.

The image forming unit 333 forms an omnifocal image or a three-dimensional image using the DFF method described above. The image forming unit 333 combines the Z stack images to form a two-dimensional image (an omnifocal image) where focus is achieved overall. The image forming unit 333 individually calculates a distance from reference coordinates to a focal point based on the coordinate information of the Z stack images to form a three-dimensional image.

After finishing image formation at the image forming unit 333, the control unit C3 stores the formed omnifocal image and/or the three-dimensional image in the storage unit 34, and instructs the display unit 32 to display the omnifocal image and/or the three-dimensional image (Step S118). In this displaying, the display unit 32 displays the instructed image in the omnifocal image and the three-dimensional image based on the instruction from the input unit 31.

According to the foregoing embodiment, in the Z stack images sequentially acquired, a shift between the Z stack images is corrected, and the corrected Z stack image is used to form an omnifocal image and a three-dimensional image. Thus, it is possible to correct a shift in the imaging region between planes vertical to the Z-direction in the Z stack images, and it is possible to highly accurately form an omnifocal image and a three-dimensional image.

It is noted that the case is described where the range in the Z-direction where the motor-operated stage 22 to be moved is the depth of focus of the scale-up optical system including the objective lens 21 or less. However, it is sufficient that a distance is close to the depth of focus. Thus, it is possible to narrow the range in the Z-direction where the motor-operated stage 22 to be moved and it is possible to reduce the number of Z stack images to be acquired.

The case is described where the control unit C1 (the Z drive control unit C12) moves the motor-operated stage 22 in the Z-direction in acquiring the Z stack images. However, such a configuration may be possible in which the motor-operated stage 22 is not moved and the objective lens 21 is moved in the Z-direction together with the revolver 23.

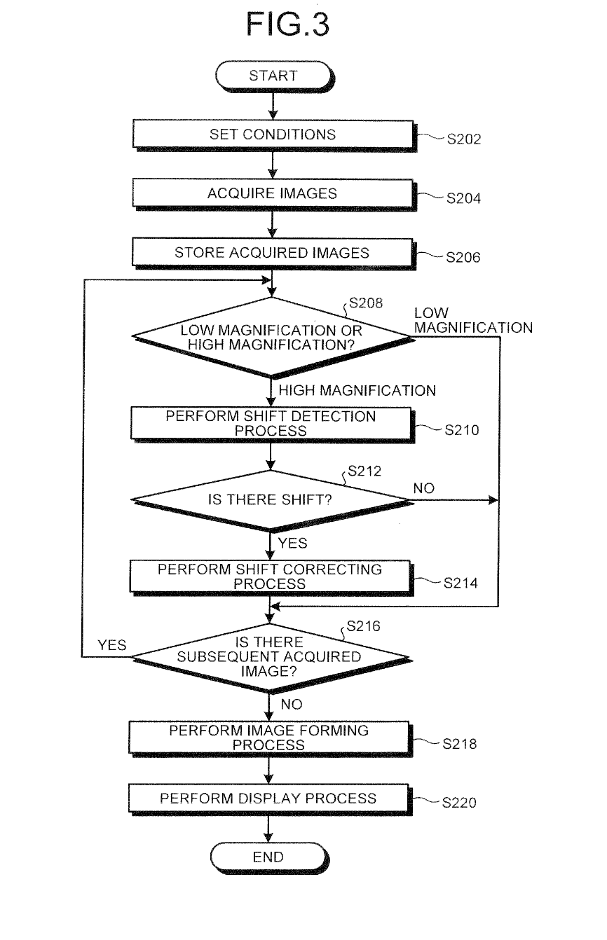

FIG. 3 is a flowchart of a first modification of image processing performed by the microscope system according to the embodiment of the present invention. First, the control unit C3 performs the image acquiring process corresponding to Steps S102 to S106 and the storing process (Step S202 to S206) described above, and acquires Z stack images.

After acquiring the Z stack images, the control unit C3 determines the imaging magnification for the acquired Z stack images (Step S208). More specifically, the control unit C3 determines whether the acquired Z stack images are captured through an objective lens with a magnification lower than a predetermined magnification or captured through an objective lens with a magnification higher than a predetermined magnification. Here, in the case where the Z stack images are captured through a low magnification objective lens (Step S208: low magnification), the control unit C3 moves to Step S216, and determines whether there is a subsequent acquired image without correcting the Z stack images.

In the case where the Z stack images are captured through a high magnification objective lens (Step S208: high magnification), the control unit C3 performs the shift correcting process corresponding to Steps S108 to S112 described above (Step S210 to S214).

After finishing the shift correcting process, the control unit C3 determines whether there is a subsequent acquired image (a Z stack image) for shift detection. In the case where there is no subsequent acquired image (Step S216: No), the control unit C3 instructs the image forming unit 333 to form an omnifocal image or a three-dimensional image using the Z stack images acquired in Step S204 or the Z stack image corrected in Step S214 (Step S218). In the case where there is a subsequent acquired image for shift detection (Step S216: Yes), the control unit C3 moves to Step S208, and processes the subsequent acquired image.

The image forming unit 333 forms an omnifocal image or a three-dimensional image using the DFF method described above. The image forming unit 333 combines the Z stack images to form a two-dimensional image (an omnifocal image) where focus is achieved overall. The image forming unit 333 individually calculates a distance from reference coordinates to a focal point based on the coordinate information of the Z stack images to form a three-dimensional image.

After finishing image formation at the image forming unit 333, the control unit C3 stores the formed omnifocal image and/or the three-dimensional image in the storage unit 34, and instructs the display unit 32 to display the omnifocal image and/or the three-dimensional image (Step S220). In this displaying, the display unit 32 displays the instructed image in the omnifocal image and the three-dimensional image based on the instruction from the input unit 31.

According to the foregoing first modification, as similar to the foregoing embodiment, in the Z stack images sequentially acquired, a shift between the Z stack images is corrected, and the corrected Z stack image is used to form an omnifocal image and a three-dimensional image. Thus, it is possible to correct a shift in the imaging region between planes vertical to the Z-direction in the Z stack images, and it is possible to highly accurately form an omnifocal image and a three-dimensional image.

Moreover, in the first modification, an omnifocal image and a three-dimensional image are formed on the Z stack images acquired through a low magnification objective lens where a shift does not tend to occur to the extent that the formation of an omnifocal image and a three-dimensional image is affected without performing the shift detection process and the shift correcting process. Thus, it is possible to reduce a load on image processing.

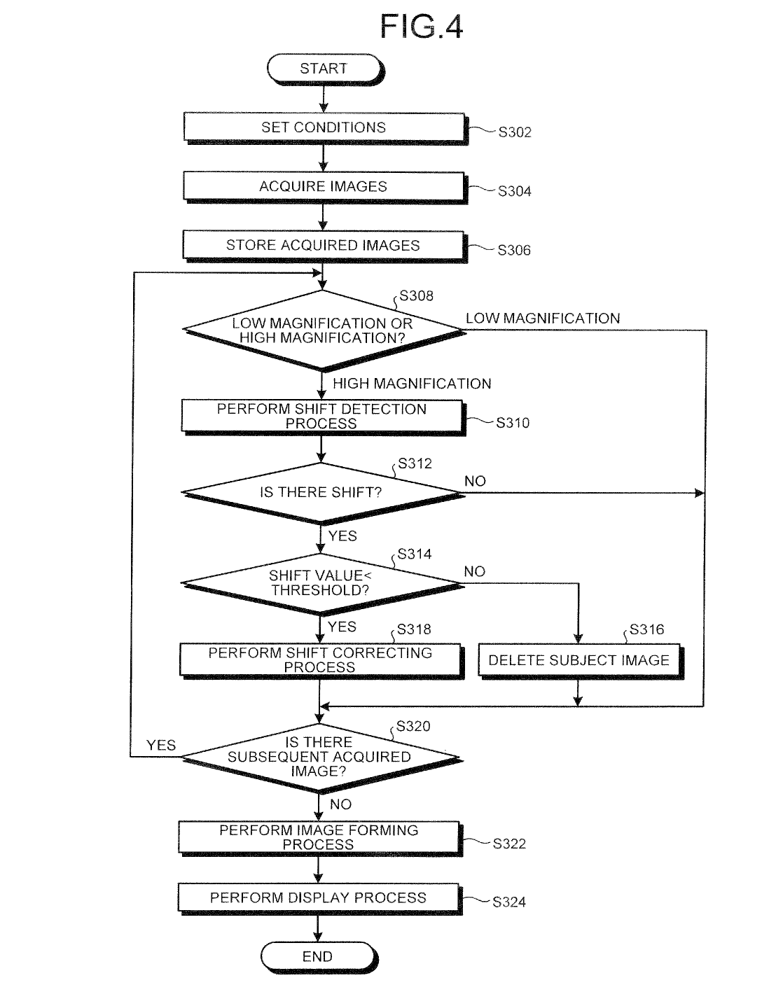

FIG. 4 is a flowchart of a second modification of image processing performed by the microscope system according to the embodiment of the present invention. First, the control unit C3 performs the image acquiring process corresponding to Steps S102 to S106 and the storing process (Steps S302 to S306) described above, and acquires Z stack images.

After acquiring the Z stack images, the control unit C3 determines whether the acquired Z stack images are captured through a low magnification objective lens or captured through a high magnification objective lens (Step S308). Here, in the case where the Z stack images are captured through a low magnification objective lens (Step S308: low magnification), the control unit C3 moves to Step S320, and determines whether there is a subsequent acquired image without correcting the Z stack images.

In the case where the Z stack images are captured through a high magnification objective lens (Step S308: high magnification), the control unit C3 instructs the detecting unit 331 to detect whether a shift occurs in the XY-direction in the pixels of the Z stack images (Step S310). Here, in the case where the detecting unit 331 detects no shift between the Z stack images (Step S312: No), the control unit C3 moves to Step S320, and determines whether there is a subsequent acquired image.

On the other hand, when the detecting unit 331 detects a shift between the Z stack images (Step S312: Yes), the control unit C3 causes the detecting unit 331 to calculate a shift value and determine whether the shift is larger or smaller than a threshold (Step S314).

Here, in the case where the shift value is the threshold or more (Step S314: No), the control unit C3 moves to Step S316, and deletes subject images (Z stack images with the shift value that is the threshold or more). After deletion, the control unit C3 moves to Step S320, and determines whether there is a subsequent acquired image.

On the other hand, in the case where the shift value is smaller than the threshold (Step S314: Yes), the control unit C3 moves to Step S318, and instructs the correcting unit 332 to correct the shift between the Z stack images.

After finishing the shift correcting process, the control unit C3 determines whether there is a subsequent acquired image (a Z stack image) for shift detection. In the case where there is no subsequent acquired image (Step S320: No), the control unit C3 instructs the image forming unit 333 to form an omnifocal image or a three-dimensional image using the Z stack images acquired in Step S304 or the Z stack image corrected in Step S318 (Step S322). Moreover, in the case where there is a subsequent acquired image for shift detection (Step S320: Yes), the control unit C3 moves to Step S308, and processes the subsequent acquired image.

After finishing image formation at the image forming unit 333, the control unit C3 stores the formed omnifocal image and/or the three-dimensional image in the storage unit 34, and instructs the display unit 32 to display the omnifocal image and/or the three-dimensional image (Step S324). In this displaying, the display unit 32 displays the instructed image in the omnifocal image and the three-dimensional image based on the instruction from the input unit 31.

According to the foregoing second modification, as similar to the foregoing embodiment, in the Z stack images sequentially acquired, a shift between the Z stack images is corrected, and the corrected Z stack image is used to form an omnifocal image and a three-dimensional image. Thus, it is possible to correct a shift in the imaging region between planes vertical to the Z-direction in the Z stack images, and it is possible to highly accurately form an omnifocal image and a three-dimensional image.

Moreover, in the second modification, an omnifocal image and a three-dimensional image are formed on the Z stack images acquired through a low magnification objective lens where a shift does not tend to occur to the extent that the formation of an omnifocal image and a three-dimensional image is affected without performing the shift detection process and the shift correcting process, and the subject Z stack image is deleted according to the size of shift values. Thus, it is possible to further reduce a load on image processing.

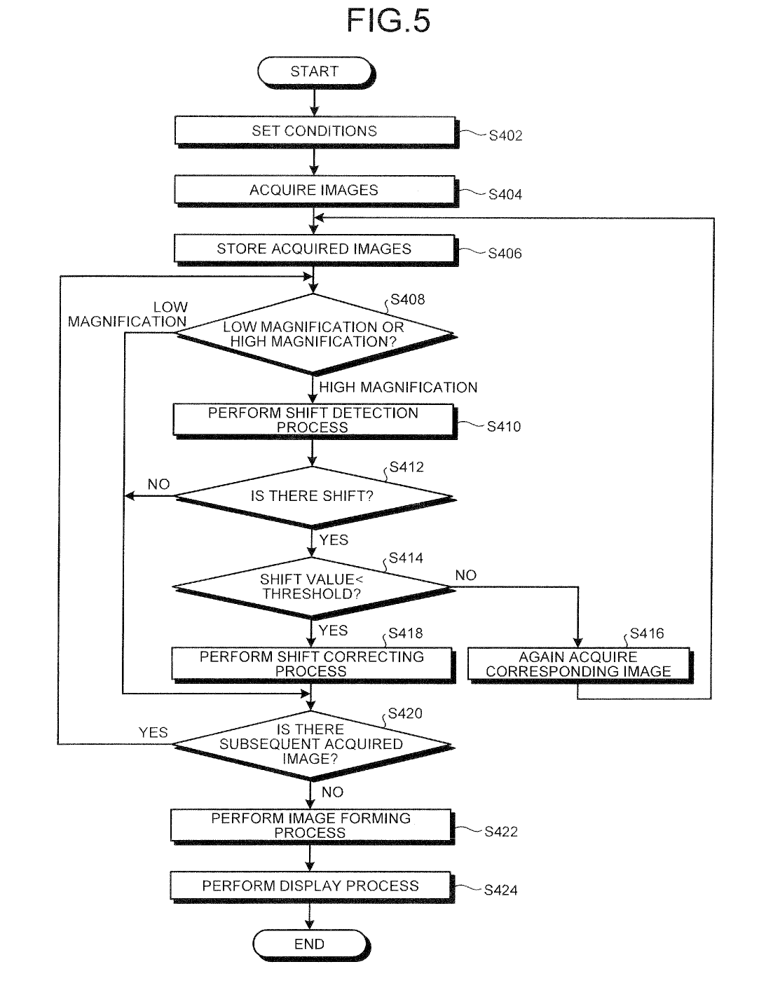

FIG. 5 is a flowchart of a third modification of image processing performed by the microscope system according to the embodiment of the present invention. First, the control unit C3 performs the image acquiring process corresponding to Steps S102 to S106 and the storing process (Step S402 to S406) described above, and acquires Z stack images.

After acquiring the Z stack images, the control unit C3 determines whether the acquired Z stack images are captured through a low magnification objective lens or captured through a high magnification objective lens (Step S408). Here, in the case where the Z stack images are captured through a low magnification objective lens (Step S408: low magnification), the control unit C3 moves to Step S420, and determines whether there is a subsequent acquired image without correcting the Z stack images.

In the case where the Z stack images are captured through a high magnification objective lens (Step S408: high magnification), the control unit C3 instructs the detecting unit 331 to detect whether a shift occurs in the XY-direction in the pixels of the Z stack images (Step S410). Here, in the case where the detecting unit 331 detects no shift between the Z stack images (Step S412: No), the control unit C3 moves to Step S420, and determines whether there is a subsequent acquired image.

On the other hand, when the detecting unit 331 detects a shift between the Z stack images (Step S412: Yes), the control unit C3 causes the detecting unit 331 to calculate a shift value and determine whether the shift is larger or smaller than a threshold (Step S414).

Here, in the case where the shift value is the threshold or more (Step S414: No), the control unit C3 moves to Step S416, and again acquires an image corresponding to Z stack images where the shift value is the threshold or more (an image at coordinates corresponding to the subject image). After again acquiring an image, the control unit C3 moves to Step S406, and again performs the processes described above.

On the other hand, in the case where the shift value is smaller than the threshold (Step S414: Yes), the control unit C3 moves to Step S418, and instructs the correcting unit 332 to correct a shift between the Z stack images.

After finishing the shift correcting process, the control unit C3 determines whether there is a subsequent acquired image (a Z stack image) for shift detection. In the case where there is no subsequent acquired image (Step S420: No), the control unit C3 instructs the image forming unit 333 to form an omnifocal image or a three-dimensional image using the Z stack images acquired in Step S404 or the Z stack image corrected in Step S418 (Step S422). Moreover, in the case where there is a subsequent acquired image for shift detection (Step S420: Yes), the control unit C3 moves to Step S408, and processes the subsequent acquired image.

After finishing image formation at the image forming unit 333, the control unit C3 stores the formed omnifocal image and/or the three-dimensional image in the storage unit 34, and instructs the display unit 32 to display the omnifocal image and/or the three-dimensional image (Step S424). In this displaying, the display unit 32 displays the instructed image in the omnifocal image and the three-dimensional image based on the instruction from the input unit 31.

According to the foregoing third modification, an omnifocal image and a three-dimensional image are formed on the Z stack images acquired through a low magnification objective lens where a shift does not tend to occur to the extent that the formation of an omnifocal image and a three-dimensional image is affected without performing the shift detection process and the shift correcting process, and a subject Z stack image is again acquired according to the size of shift values. Thus, it is possible to reduce a load on image processing and to form a highly accurate omnifocal image and a three-dimensional image.

It is noted that again acquiring the subject image in Step S416 in the foregoing third modification and deleting the subject image in Step S316 in the second modification may be selectively processed. Thus, it is possible to select whether an image is again acquired or the image is deleted depending on the situations for selective, efficient processing.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image processing device that forms at least one of an omnifocal image and a three-dimensional image based on a group of images captured while moving along a fixed axis, the image processing device comprising:
a detecting unit that detects a shift in a plane vertical to the axis of images in the group of the images;
a correcting unit that corrects the shift according to a result detected at the detecting unit; and
an image forming unit that forms at least one of an omnifocal image and a three-dimensional image based on the group of the images including at least one of images captured while moving along the fixed axis and an image corrected at the correcting unit.

2. The image processing device according to claim 1, wherein the group of the images are images captured through a microscope having a plurality of objective lenses with different magnifications,
the image processing device further comprises a determining unit that determines an imaging magnification for the group of the images, and
when the determining unit determines that the group of the images are images captured through an objective lens with a magnification lower than a predetermined magnification, the image forming unit forms at least one of an omnifocal image and a three-dimensional image using the group of the images.

3. The image processing device according to claim 1, wherein when the detecting unit detects an image where a shift occurs, the detecting unit calculates a shift value of the shift and determines whether the shift value is larger or smaller than a threshold, and
the detecting unit deletes the image when the shift value is larger than the threshold.

4. The image processing device according to claim 1, wherein when the detecting unit detects an image where a shift occurs, the detecting unit calculates a shift value of the shift and determines whether the shift value is larger or smaller than a threshold, and
the detecting unit again acquires a corresponding image when the shift value is larger than the threshold.

5. An image display system comprising:
the image processing device according to claim 1; and
a display unit configured to display at least one of the omnifocal image and the three-dimensional image formed at the image processing device.
